(19) United States
(12) Patent Application Publication
(10) Pub. No.: US 2026/0148728 A1
(43) Pub. Date: May 28, 2026

(54) SETTING METHOD, METHOD OF MANUFACTURING ACTIVE NOISE REDUCTION DEVICE, RECORDING MEDIUM, AND INFORMATION TERMINAL

(71) Applicant: Panasonic Automotive Systems Co., Ltd., Kanagawa (JP)

(72) Inventor: Wataru NOGUCHI, Osaka (JP)

(73) Assignee: Panasonic Automotive Systems Co., Ltd., Kanagawa (JP)

(21) Appl. No.: 19/384,643

(22) Filed: Nov. 10, 2025

(30) Foreign Application Priority Data
Nov. 22, 2024 (JP) 2024-204141

(51) Int. Cl. G10K 11/178

(52) U.S. Cl. CPC G10K 11/1787

(57) ABSTRACT

A setting method includes acquiring a plurality of instances of measurement data of an acoustic transfer function from a position of a loudspeaker to a position of a microphone, identifying a frequency band in which measurement variation of the acquired instances of measurement data is greater than a threshold value, and storing setting information in a storage of an active noise reduction device, the setting information being information for configuring the active noise reduction device with a setting that prevents output of the cancellation sound when noise corresponding to the identified frequency band is detected.

### CROSS REFERENCE TO RELATED APPLICATION

The present application is based on and claims priority of Japanese Patent Application No. 2024-204141 filed on Nov. 22, 2024.

### FIELD

The present disclosure relates to an active noise reduction device that actively reduces noise.

### BACKGROUND

Patent Literature (PTL) 1 discloses a technique relating to the estimation of a secondary path transfer function in active noise control.

### CITATION LIST

### Patent Literature

PTL 1: Japanese Unexamined Patent Application Publication (Translation of PCT Application) No. 2018-527624

### SUMMARY

The present disclosure provides a setting method capable of improving upon the above related art.

A setting method according to one Aspect of the present disclosure is a setting method relating to an active noise reduction device and to be executed by a computer, the active noise reduction device, when noise caused by a revolution of a power source of a mobile object is detected in a space of the mobile object where a loudspeaker and a microphone are provided, reducing the noise detected, by outputting cancellation sound from the loudspeaker. The setting method includes acquiring a plurality of instances of measurement data of an acoustic transfer function from a position of the loudspeaker to a position of the microphone, identifying a frequency band in which measurement variation of the plurality of instances of measurement data acquired is greater than a threshold value, and storing setting information in a storage of the active noise reduction device, the setting information being information for configuring the active noise reduction device with a setting that prevents output of the cancellation sound when noise corresponding to the frequency band identified is detected.

The setting method according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing a functional configuration of an active noise reduction device that conforms to a single-frequency adaptive notch filter (SAN) algorithm.

FIG. 2 is a diagram showing the relationship between a noise signal and a cancellation signal in the SAN algorithm.

FIG. 3 is a block diagram showing a functional configuration of an active noise reduction device that conforms to a SAN-filtered-x least mean squares (LMS) algorithm.

FIG. 4 is a diagram showing the relationship between noise and cancellation sound in the SAN-filtered-x LMS algorithm.

FIG. 5 is a schematic diagram of a vehicle that includes an active noise reduction device according to an embodiment.

FIG. 6 is a block diagram showing a functional configuration of the active noise reduction device according to the embodiment.

FIG. 7 is a block diagram showing a functional configuration of a setting system according to the embodiment.

FIG. 8 is a flowchart of exemplary operation 1 of the setting system according to the embodiment.

FIG. 9 is a diagram showing a specific example of an except band.

FIG. 10 is a flowchart of exemplary operation 2 of the setting system according to the embodiment.

FIG. 11 is a flowchart showing details of update processing.

FIG. 12 is a diagram for describing a genetic algorithm (a method of generating a third transfer function).

FIG. 13 is a diagram for describing a round robin algorithm.

FIG. 14 is a flowchart of exemplary operation 3 of the setting system according to the embodiment.

FIG. 15 is a flowchart of a method of manufacturing the active noise reduction device according to the embodiment.

### DESCRIPTION OF EMBODIMENTS

Embodiments will be described hereinafter in detail with reference to the drawings. Note that each embodiment described below illustrates a generic or specific example of the present disclosure. Numerical values, shapes, materials, constituent elements, arrangement positions and connection forms of constituent elements, steps, a sequence of steps, and so on in the following embodiments are mere examples and do not intend to limit the scope of the present disclosure. Among the constituent elements described in the following embodiments, those that are recited in none of the independent claims, which represent the broadest concept, are described as optional constituent elements.

The drawings are schematic diagrams and do not always strictly follow the actual configuration. In the drawings, constituent elements that are substantially identical are given the same reference numerals, and redundant descriptions may be omitted or simplified.

### Embodiment

### [Noise Signal Reducing Method Using SAN Algorithm]

The following embodiment describes an active noise reduction device with improved noise reduction performance based on a SAN-filtered-x LMS algorithm. SAN is an abbreviation of a single-frequency adaptive notch filter, and LMS is an abbreviation of least mean squares.

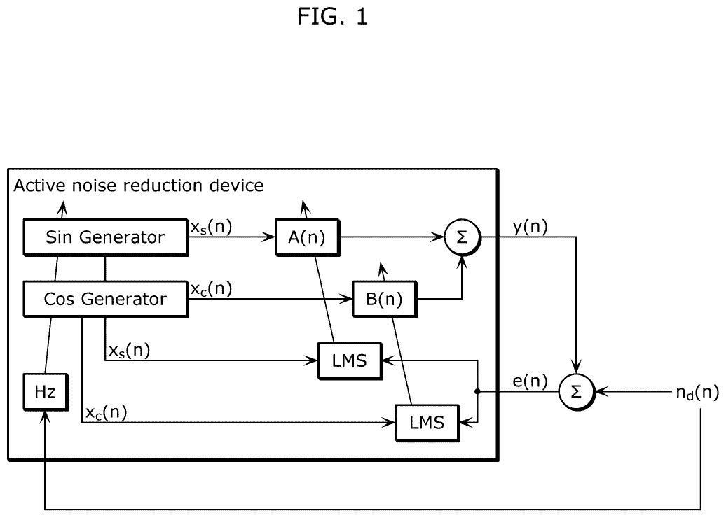

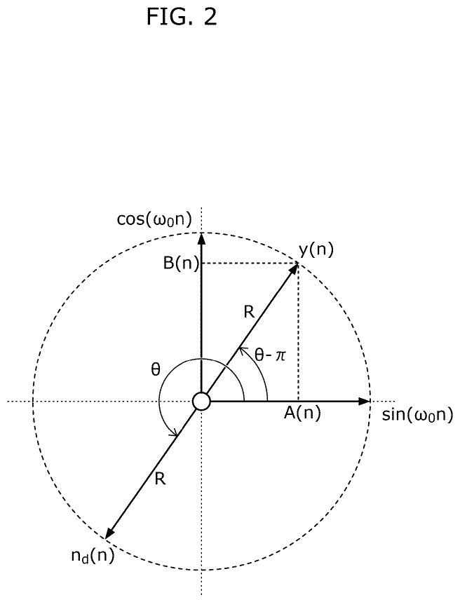

Before the description of the active noise reduction device according to the embodiment, a noise signal reducing method using the SAN algorithm will be described. FIG. 1 is a block diagram showing a functional configuration of an active noise reduction device that conforms to the SAN algorithm. FIG. 2 is a diagram showing the relationship between a noise signal (a sinusoidal signal of noise) and a cancellation signal in the SAN algorithm. In the following noise signal reducing method using the SAN algorithm, the noise signal is described as a single-frequency sinusoidal signal.

In FIGS. 1 and 2, n is an integer greater than or equal to zero and indicates the sampling number in a discrete time system. When the frequency of the noise signal that is reduced is given as f₀ [Hz], normalized angular frequency ω₀[rad] is expressed by Expression 1 below.

$${ω}_{0} = 2 π {f}_{0} {T}_{s} = 2 π {f}_{0} / {f}_{s} \qquad [ Expression 1 ]$$

In Expression 1, Tₛ[sec] denotes the sampling period, and fₛ [Hz] denotes the sampling frequency. Using normalized angular frequency ω₀, nTₛ that represents the discrete time is expressed by n.

Sinusoidal signal n_{d}(n) of noise is expressed by Expression 2 below using normalized angular frequency ω₀, amplitude R, and phase θ[rad].

$${n}_{d} ( n ) = R sin ( {ω}_{0} n + θ ) \qquad [ Expression 2 ]$$

In order to reduce n_{d}(n), a cancellation signal is generated. Since cancellation signal y(n) is the same in amplitude as and opposite in phase to n_{d}(n), cancellation signal y(n) is expressed by Expression 3 given below.

$$\begin{matrix}y ( n ) = R sin \{ {ω}_{0} n + ( 0 - π ) \} \\ = A ( n ) sin ( {ω}_{0} n ) + B ( n ) cos ( {ω}_{0} n )\end{matrix} \qquad [ Expression 3 ]$$

A(n) and B(n) are filter factors of the adaptive filter. Amplitude R of cancellation signal y(n) is expressed by the square root of A(n)²+B(n)², and phase (θ−π) is expressed by the inverse tangent (arc tangent) of B(n)/A(n). Thus, the amplitude of the cancellation signal can be changed by changing the magnitudes of filter factors A(n) and B(n) of the adaptative filter, and the phase of the cancellation signal can be changed by changing the ratio of filter factors A(n) and B(n) of the adaptive filter.

Here, filter factors A(n) and B(n) of the adaptative filter are optimized so as to minimize e(n) in accordance with the LMS algorithm, where e(n) is an error signal caused by interference between the noise signal and the cancellation signal. In this way, the noise signal is reduced.

### [Noise Reducing Method Using SAN-Filtered-x LMS Algorithm]

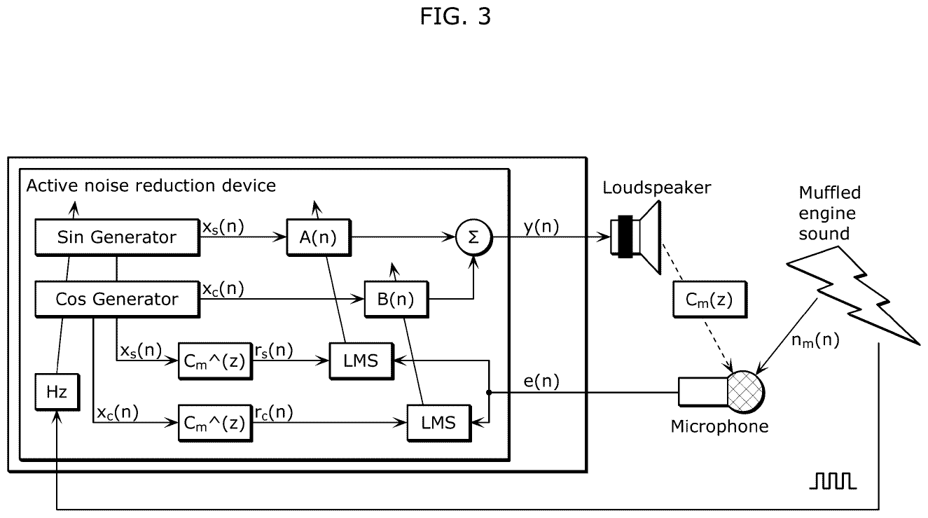

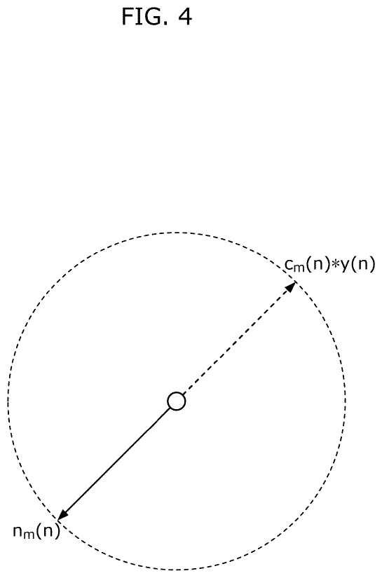

Next, a noise reducing method using a SAN-filtered-x LMS algorithm will be described. FIG. 3 is a block diagram showing a functional configuration of an active noise reduction device that conforms to the SAN-filtered-x LMS algorithm. FIG. 4 is a diagram showing the relationship between noise and cancellation sound in the SAN-filtered-x LMS algorithm. In the following description of the noise reducing method using the SAN-filtered-x LMS algorithm, muffled engine sound is regarded as noise. The muffled engine sound is noise that is instantaneously approximate to a single-frequency sinusoidal wave.

The cancellation signal propagates through a loudspeaker, vehicle's interior space, and a microphone and is input to the active noise reduction device. This transduction pathway is expressed by acoustic transfer function Cₘ(z), where z means z-transform. The SAN-filtered-x LMS algorithm is the algorithm that is based on the above-described SAN algorithm and that further takes acoustic transfer function Cₘ(z) into account.

In FIGS. 3 and 4, simulated transfer function Cₘ\hat{ }(z) is the transfer function (filter) that simulates acoustic transfer function Cₘ(z). Here, nₘ(n) is the muffled engine sound at the position of the microphone having frequency f₀ [Hz], and cₘ(n) is the impulse response of discrete time n for Cₘ(z). Moreover, cₘ(n)*y(n) represents the cancellation sound at the position of the microphone, and * means the convolution operator. In the case of actually reducing the muffled engine sound, convolution is an integration of continuous times, but in the following description, it is assumed that convolution is the product-sum operation of discrete times.

In the noise reducing method based on the SAN-filtered-x LMS algorithm, processing from (1) to (5) described below is repeatedly executed so that filter factors A(n) and B(n) converge to optimum values.
(1) Frequency f₀ [Hz] of muffled engine sound nₘ(n) is detected based on a signal that indicates the rotational frequency of the engine.
(2) Sinusoidal wave xₛ(n) and cosine wave x_{c}(n) that have a frequency of f₀ [Hz] are generated, multiplied respectively by factors A(n) and B(n), and added together to generate cancellation signal y(n) expressed by Expression 4.

$$y ( n ) = A ( n ) {X}_{s} ( n ) + B ( n ) {X}_{c} ( n ) \qquad [ Expression 4 ]$$

(3) Cancellation sound is output from the loudspeaker in accordance with cancellation signal y(n). At the position of the microphone, residual sound (error signal) e(n) caused by interference between cancellation sound cₘ(n)*y(n) and muffled engine sound nₘ(n) is detected by the microphone.

(4) Sinusoidal wave xₛ(n) and cosine wave x_{c}(n) are filtered by Cₘ\hat{ }(z) to generate sinusoidal wave rₛ(n) and cosine wave r_{c}(n), respectively.

(5) Filter factors A(n) and B(n) are updated based on LMS update formulas expressed by Expressions 5 and 6, where μ is the step-size parameter that determines the amount of updating (the rate of updating) of filter factors A(n) and B(n) per sampling unit.

$$A ( n + 1 ) = A ( n ) - μ {r}_{s} ( n ) e ( n ) \qquad [ Expression 5 ]$$

$$B ( n + 1 ) = B ( n ) - μ {r}_{c} ( n ) e ( n ) \qquad [ Expression 6 ]$$

Here, additional information is provided for the muffled engine sound. The muffled engine sound is noise that is generated in the space of the vehicle interior when vibrations and exhaust noise caused by explosion propagate through the chassis or the like of the vehicle in the process of aspiration of air to the engine and compression, explosion, and exhaust in the engine. For example, in the case where the engine is a four-cylinder four-cycle engine, two revolutions of the shaft cause explosions in all of the four cylinders, and two explosions occur per revolution. This produces noise having a frequency component that is a double of the rotational frequency of the engine. This noise is called, for example, second-order muffled sound (second-order component) caused by the engine's revolutions and may be of concern because the second-order component has a higher noise level than the other components. Not only the second-order component but also a harmonic component may also be of concern.

In the case where the engine is a six-cylinder engine, a third-order component has a high noise level, and in the case where the engine is a three-cylinder engine, a 1.5-order component has a high noise level. That is, if the number of cylinders in the engine is reduced by downsizing, the muffled engine sound has a lower dominant frequency.

### [Configuration of Active Noise Reduction Device]

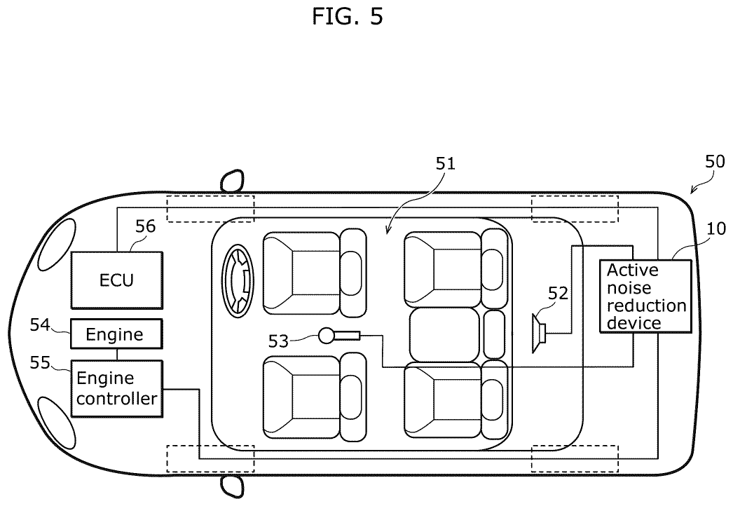

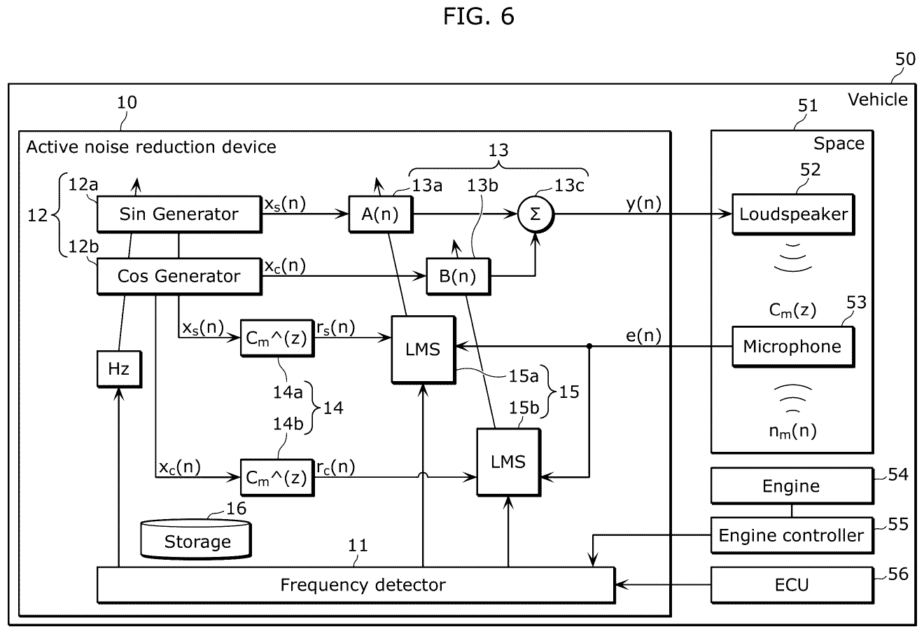

Next, a configuration of the active noise reduction device according to the embodiment will be described. FIG. 5 is a schematic diagram of a vehicle that includes the active noise reduction device according to the embodiment. FIG. 6 is a block diagram showing a functional configuration of the active noise reduction device according to the embodiment.

As shown in FIG. 5, active noise reduction device 10 is mounted on vehicle 50 to reduce noise in space 51 in the vehicle interior. Vehicle 50 may be a gasoline-powered vehicle or a hybrid vehicle. Examples of the hybrid vehicle as used herein include series-, parallel-, and split-system hybrid vehicles. Examples of the hybrid vehicle as used herein also include a plug-in hybrid vehicle.

Loudspeaker 52 and microphone 53 are provided in space 51. To simplify the description, only one set of loudspeaker 52 and microphone 53 is shown in FIGS. 5 and 6, but in actually, a plurality of sets of loudspeakers 52 and microphones 53 are provided in space 51, and a plurality of sets of loudspeakers 52 and microphones 53 are used to reduce noise.

Vehicle 50 further includes engine 54, engine controller 55, and electronic control unit (ECU) 56.

Engine 54 is a drive that serves as a power source of vehicle 50 and a source of noise in space 51. For example, engine 54 may be arranged in a space different from space 51. Specifically, engine 54 is provided in a space formed in the bonnet of vehicle 50.

Engine controller 55 controls (drives) engine 54 in accordance with, for example, a driver's operation of accelerating vehicle 50. Engine controller 55 also outputs a pulse signal (engine pulse signal) responsive to the engine speed (frequency) of engine 54 to active noise reduction device 10. For example, the frequency of the pulse signal may be proportional to the engine speed (frequency) of engine 54. The pulse signal is specifically an analog signal such as a so-called tacho pulse.

ECU 56 is a computer that performs electronic control of vehicle 50. ECU 56 outputs a digital signal that indicates the engine speed (frequency) of engine 54 to active noise reduction device 10.

Note that ECU 56 and active noise reduction device 10 communicate with each other via a controller area network (CAN).

Active noise reduction device 10 is an active-type noise reduction device that reduces noise at the installation position of microphone 53 by means of cancellation sound that is output from loudspeaker 52. For example, active noise reduction device 10 may be implemented by a microprocessor such as a microcontroller or a digital signal processor (DSP) and storage 16. Storage 16 is specifically semiconductor memory or the like.

As shown in FIG. 6, active noise reduction device 10 specifically includes frequency detector 11, reference-signal generator 12, adaptive filter 13, corrector 14, updater 15, and storage 16. Reference-signal generator 12 includes sinusoidal-wave generator 12a and cosine-wave generator 12b, and adaptative filter 13 includes adaptive filters 13a and 13b and adder 13c. Corrector 14 includes correctors 14a and 14b, and updater 15 includes updaters 15a and 15b. Functions of these constituent elements are achieved by, for example, causing the microprocessor such as a DSP to execute computer programs stored in storage 16.

Frequency detector 11 acquires a signal that indicates the engine speed of engine 54 (an analog signal that is output from engine controller 55 or a digital signal that is output from ECU 56) and detects (calculates) the (instantaneous) frequency of the muffled engine sound in accordance with the acquired signal. The relationship of frequency f₀ [Hz] of the muffled engine sound, engine speed RPM[rpm] of engine 54, and order ORD of the muffled engine sound is expressed by Expression 7 given below. In other words, Expression 7 is an equation for detecting a first frequency that corresponds to the engine speed.

$$f 0 = ( RPM ) ( ORD ) / 60 \qquad [ Expression 7 ]$$

Sinusoidal-wave generator 12a outputs a sinusoidal wave of the frequency detected by frequency detector 11 as reference signal xₛ(n), where n is an integer greater than or equal to zero and indicates the sampling number in the discrete time system. Reference signal xₛ(n) is output to adaptative filter 13a, corrector 14a, and updater 15a.

Cosine-wave generator 12b outputs a cosine wave of the frequency detected by frequency detector 11 as reference signal x_{c}(n). Reference signal x_{c}(n) is output to adaptive filter 13b, corrector 14b, and updater 15b.

Adaptative filter 13a multiplies reference signal xₛ(n) output from sinusoidal-wave generator 12a by filter factor A(n). Filter factor A(n) is successively updated by updater 15a. Cancellation signal A(n)xₛ(n) obtained by multiplying reference signal xₛ(n) by filter factor A(n) is output to adder 13c.

Adaptative filter 13b multiplies reference signal x_{c}(n) output from cosine-wave generator 12b by filter factor B(n). Filter factor B(n) is successively updated by updater 15b. Cancellation signal B(n)x_{c}(n) obtained by multiplying reference signal x_{c}(n) by filter factor B(n) is output to adder 13c.

Adder 13c adds cancellation signal A(n)xₛ(n) output from adaptative filter 13a and cancellation signal B(n)x_{c}(n) output from adaptive filter 13b together so as to generate cancellation signal y(n). Adder 13c outputs generated cancellation signal y(n) to loudspeaker 52.

Corrector 14a generates corrected reference signal rₛ(n) by correcting (filtering) reference signal xₛ(n) with use of simulated transfer function Cₘ\hat{ }(z). Corrected reference signal rₛ(n) generated is output to updater 15a.

Note that simulated transfer function Cₘ\hat{ }(z) is the transfer function that simulates acoustic transfer function Cₘ(z) from the position of loudspeaker 52 to the position of microphone 53. Simulated transfer function Cₘ\hat{ }(z) is specifically a gain and a phase (a phase delay) at each frequency. For example, simulated transfer function Cₘ\hat{ }(z) may be measured in advance at each frequency in the space and stored in storage 16 of active noise reduction device 10. That is, storage 16 stores frequencies, and gains and phases for use in correcting signals at each frequency.

Corrector 14b generates corrected reference signal r_{c}(n) by correcting (filtering) reference signal x_{c}(n) with use of simulated transfer function Cₘ\hat{ }(z). Corrected reference signal r_{c}(n) generated is output to updater 15b.

Updater 15a calculates filter factor A(n) on the basis of corrected reference signal rₛ(n) acquired from corrector 14a and error signal e(n) output from microphone 53, and outputs calculated filter factor A(n) to adaptative filter 13a. Updater 15a also successively updates filter factor A(n) by using Expression 5 given above. That is, updater 15a updates filter factor A(n) by using an update formula including step-size parameter μ (a parameter relating to the rate of updating).

Updater 15b calculates filter factor B(n) on the basis of corrected reference signal r_{c}(n) acquired from corrector 14b and error signal e(n) output from microphone 53, and outputs calculated filter factor B(n) to adaptive filter 13b. Updater 15b also successively updates filter factor B(n) by using Expression 6 given above. That is, updater 15b updates filter factor B(n) by using an update formula including step-size parameter p.

### [Configuration of Setting System]

As described above, storage 16 of active noise reduction device 10 stores the pre-measured simulated transfer function. The actual acoustic transfer function in vehicle 50 varies under the influence of factors such as people in vehicle 50 and the placement of baggage even if the same active noise reduction device 10 as an industrial product is installed in the same vehicle 50 as an industrial product. Moreover, sound deadening performance may vary for each vehicle 50 because overall sound input-output characteristics vary substantially for different acoustic characteristics of the loudspeaker. This may make a large difference between the actual acoustic transfer function and the simulated transfer function stored in advance in storage 16, resulting in the incapability of the cancellation sound to sufficiently reduce noise or the possibility that the cancellation sound may increase noise (in other words, the cancellation sound itself may become noise).

In view of this, the inventors have found a configuration that makes settings of active noise reduction device 10 so as to exclude a frequency band that is susceptible to changes in the acoustic transfer function from frequency bands targeted for noise reduction. Active noise reduction device 10 that has undergone such settings stops the output of the cancellation sound when the frequency that is detected by frequency detector 11 and that corresponds to the engine speed of engine 54 corresponds to a frequency band susceptible to changes in the acoustic transfer function. This suppresses an increase in noise caused by the cancellation sound.

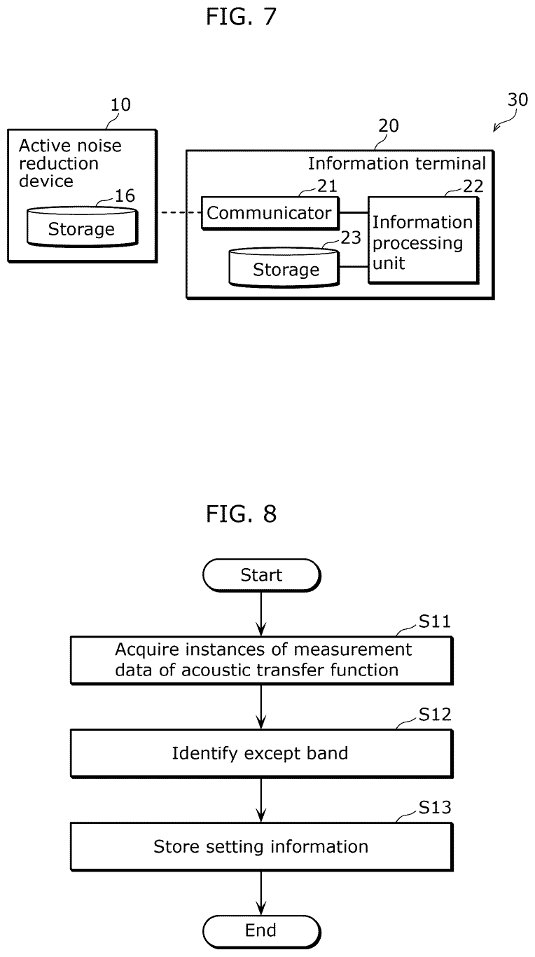

Hereinafter, a configuration of a setting system for making such settings will be described. FIG. 7 is a block diagram showing a functional configuration of the setting system.

As shown in FIG. 7, setting system 30 includes active noise reduction device 10 and information terminal 20. The configuration of active noise reduction device 10 has already been described, and therefore detailed description thereof shall be omitted.

Information terminal 20 is used to make various settings of active noise reduction device 10 and is specifically a personal computer or a digitizing tablet. Information terminal 20 includes communicator 21, information processing unit 22, and storage 23.

Communicator 21 is a communication circuit that allows information terminal 20 to communicate with active noise reduction device 10 via a local communication network. Communicator 21 may be a cable communication circuit for cable communication or a wireless communication circuit for wireless communication. Although not shown, active noise reduction device 10 also includes a communication circuit corresponding to communicator 21.

Information processing unit 22 performs information processing for making various settings of active noise reduction device 10. For example, information processing unit 22 may be realized by a microcomputer, but it may be realized by a processor. Functions of information processing unit 22 may be realized by, for example, a microcomputer or the processor that configures information processing unit 22 executing computer programs stored in storage 23.

Storage 23 is a storage device for storing information that is necessary for the information processing performed by information processing unit 22, and computer programs that are executed by information processing unit 22. The computer programs stored in storage 23 include an application program dedicated for setting system 30 (hereinafter, also referred to as a dedicated application). For example, storage 23 may be realized by semiconductor memory, but it may be realized by any other device such as a hard disk drive (HDD).

Note that setting system 30 may be realized as a client server system and may further include a server device (cloud server), in addition to active noise reduction device 10 and information terminal 20. In this case, part of the entire processing to be executed by information terminal 20 in the following embodiment may be executed by the server device. For example, information terminal 20 may be used as a user interface for communication with an operator, and substantial information processing may be performed by the server device.

### [Exemplary Operation 1 of Setting System]

The next description is given regarding exemplary operation 1 of making settings of active noise reduction device 10 so as to exclude frequency bands susceptible to changes in the acoustic transfer function from a frequency band targeted for noise reduction. FIG. 8 is a flowchart of exemplary operation 1 of setting system 30.

In vehicle 50 equipped with active noise reduction device 10, an operator measures, multiple times, an acoustic transfer function from the position of the loudspeaker to the position of the microphone in the same or different measurement environments. The measurement uses a measuring instrument such as a frequency response analyzer (FRA). The frequency band targeted for noise reduction may, for example, be a frequency band ranging from FsHz to FeHz (Fs and Fe are positive integers), and in a single measurement of the acoustic transfer function, for example, a gain and a phase are measured in increments of 1 Hz in the frequency band of FsHz to FeHz. That is, (Fe−Fs+1) sets of the gain and the phase are measured with a single measurement of the acoustic transfer function.

The operator inputs such a plurality of instances of measurement data of the acoustic transfer function to information terminal 20 that is executing a dedicated application. Information processing unit 22 of information terminal 20 acquires the plurality of instances of measurement data of the acoustic transfer function (S11). For example, the measurement data may be input to information terminal 20 via memory such as universal serial bus (USB) memory, but there are no particular limitations on the method of inputting the measurement data to information terminal 20.

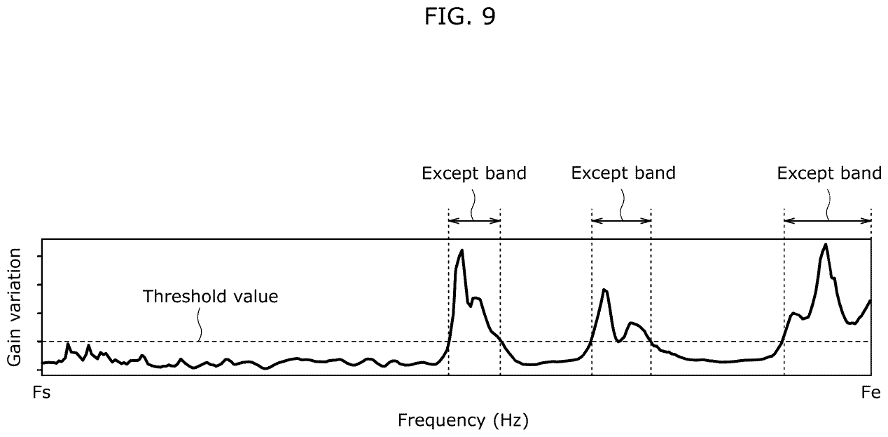

Information processing unit 22 identifies a frequency band in which measurement variation of the acquired instances of measurement data is greater than a threshold value (hereinafter, also referred to as an except band) (S12). The except band can be said as a frequency band susceptible to changes in the acoustic transfer function. For example, in the case of identifying an except band based on the gain out of the gain and the phase, a set of frequencies at which measurement variation (distribution) of a plurality of instances of measured gains is greater than the threshold value is determined as the except band. FIG. 9 is a diagram showing a specific example of the except band. In FIG. 9, the vertical axis indicates the measurement variations, and the horizontal axis indicates the frequency. The threshold value may be set as appropriate by empirical or experimental means by, for example, the designer of active noise reduction device 10.

Then, information processing unit 22 transmits setting information to active noise reduction device 10 via communicator 21 in order to store the setting information in storage 16 of active noise reduction device 10 (S13). This setting information is information for configuring active noise reduction device 10 with a setting that prevents output of the cancellation sound when noise is detected that has a frequency corresponding to the except band identified in step S12. That is, active noise reduction device 10 that stores the setting information in storage 16 stops the output of the cancellation sound when the frequency corresponding to the engine speed of engine 54 detected by frequency detector 11 corresponds to the except band susceptible to changes in the actual acoustic transfer function.

In this way, when noise is detected that has a frequency corresponding to the except band susceptible to changes in the actual acoustic transfer function, active noise reduction device 10 that has undergone the setting process in step S13 does not output the cancellation sound, thereby suppressing an increase in noise caused by the cancellation sound.

### [Exemplary Operation 2 of Setting System]

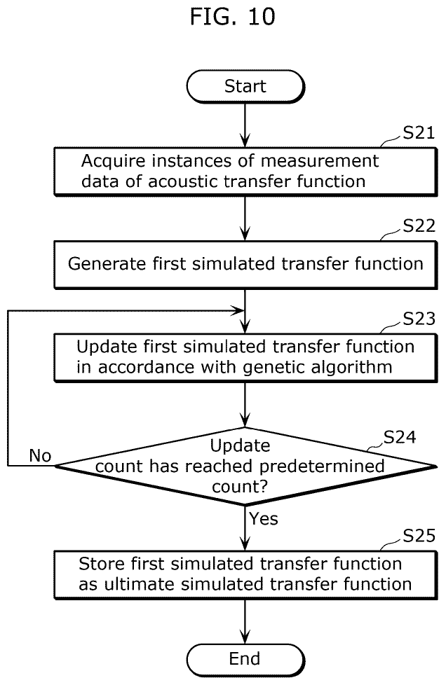

As described above, storage 16 of active noise reduction device 10 stores the simulated transfer function obtained by actual measurement. Here, how to generate the simulated transfer function (a method of generating the simulated transfer function) is susceptible to consideration. The inventors have found a method of generating the simulated transfer function in accordance with a genetic algorithm. The following description is given regarding an operation (exemplary operation 2) of generating a simulated transfer function in accordance with the genetic algorithm and storing the generated simulated transfer function in storage 16. FIG. 10 is a flowchart of exemplary operation 2 of setting system 30.

An operator inputs a plurality of instances of measurement data of the acoustic transfer function to information terminal 20 that is executing a dedicated application. Information processing unit 22 of information terminal 20 acquires the instances of measurement data of the acoustic transfer function (S21). The processing in step S21 is similar to the processing in step S11.

Information processing unit 22 generates a first simulated transfer function based on the acquired instances of measurement data (S22). For example, information processing unit 22 may generate the first simulated transfer function by averaging the acquired instances of measurement data.

The first simulated transfer function includes N first parameters that correspond respectively to N different frequency values. The following description is given regarding a case where the first parameters are gains, but the first parameters may be phases. In the case where a gain and a phase are measured in increments of 1 Hz in a frequency band of FsHz to FeHz, N=Fe−Fs+1 is satisfied, and the frequency values are integers greater than or equal to Fs and less than or equal to Fe. Note that N may be a natural number greater than or equal to two.

Information processing unit 22 updates the first simulated transfer function in accordance with the genetic algorithm (S23). Details of the update processing in step S23 will be described later. Information processing unit 22 determines whether an update count has reached a predetermined count (S24). If it is determined that the update count has not yet reached the predetermined count (No in S24), information processing unit 22 again performs the update processing (S23) and the determination processing (S24). If it is determined that the update count has reached the predetermined count (Yes in S24), information processing unit 22 stores the first simulated transfer function that has been updated for the predetermined count, as an ultimate simulated transfer function in storage 16 of active noise reduction device 10 (S25). Specifically, information processing unit 22 transmits the ultimate simulated transfer function to active noise reduction device 10 via communicator 21 in order to store the ultimate simulated transfer function in storage 16 of active noise reduction device 10.

Note that the predetermined count is a fixed count that is empirically or experimentally determined by, for example, the designer of active noise reduction device 10. However, information processing unit 22 may repeat the update until noise reduction performance of the first simulated transfer function converges (show no improvements). In this case, the predetermined count corresponds to a count that is necessary to cause the noise reduction performance of the first simulated transfer function to converge.

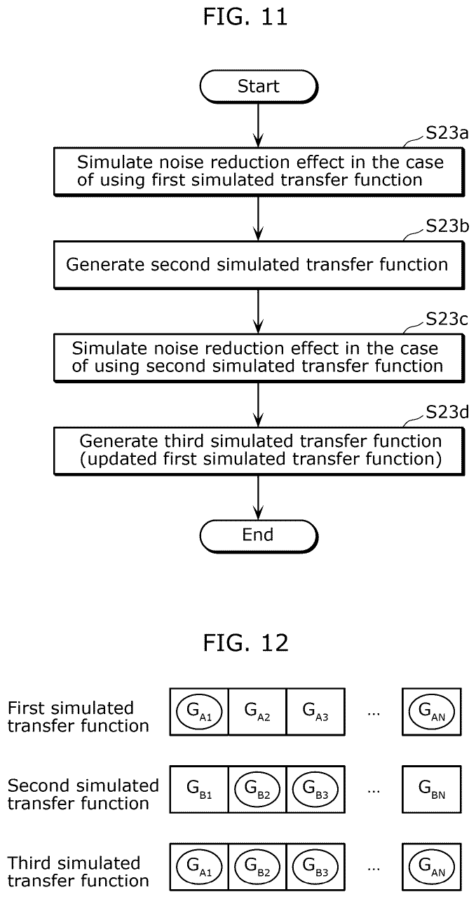

Here, details of the update processing in step S23 will be described. FIG. 11 is a flowchart showing the details of the update processing.

In the update processing, information processing unit 22 simulates a noise reduction effect (e.g., frequency characteristics of the noise level) of active noise reduction device 10 that is assumed to be achieved in the case of using the first simulated transfer function before updating (S23a). The simulation is implemented by executing a computer program for simulation stored in advance in storage 23 of information terminal 20.

Then, information processing unit 22 generates a second simulated transfer function including N second parameters by changing each of the N first parameters randomly within a predetermined numerical range (S23b). The predetermined numerical range may, for example, be between ±5 dB, but may be determined empirically or experimentally by, for example, the designer of active noise reduction device 10.

Then, information processing unit 22 simulates a noise reduction effect of active noise reduction device 10 that is assumed to be achieved in the case of using the generated second simulated transfer function (S23c).

Then, on the basis of the result of processing in steps S23a to S23c, information processing unit 22 generates a third simulated transfer function including N third parameters and determines the generated third simulated transfer function as an updated first simulated transfer function (S23d). FIG. 12 is a diagram for describing a method of generating the third transfer function.

As shown in FIG. 12, it is assumed that the first simulated transfer function includes N first parameters (gains) G_{A1}, G_{A2}, G_{A3}, . . . , and G_{AN}, and the second simulated transfer function includes N first parameters (gains) G_{B1}, G_{B2}, G_{B3}, . . . , and G_{BN}. Numerical values refer to frequency values.

Information processing unit 22 generates the third simulated transfer function by selecting, as each third parameter, a parameter that shows a lower noise level during simulation as a result of simulations in steps S23a and S23c (a parameter with its number enclosed with an ellipse in FIG. 12), from first and second parameters that correspond to one frequency value. That is, information processing unit 22 generates the third simulated transfer function by cream-skimming parameters for each frequency value.

In this way, by updating the first simulated transfer function for the predetermined count in accordance with the genetic algorithm, setting system 30 is capable of generating the first simulated transfer function that is considered to achieve a high noise reduction effect and storing the generated first simulated transfer function as a simulated transfer function in storage 16 of active noise reduction device 10, the simulated transfer function being used for the generation of the cancellation sound.

In the generation of the second simulated transfer function in step S23b, although each of the N first parameters is described as being changed randomly within the predetermined numerical range, but step S23b may change the first parameters greatly and randomly beyond the predetermined range with a relatively low predetermined probability such as a several percent. That is, the first parameters may be mutated. This reduces the possibility that the first parameters will fall into so-called local solutions and fail to approach optimum solutions.

In the generation of the third simulated transfer function in step S23d, parameters are selected on condition that the noise level is low during simulation, but in addition to or instead of the noise level, high audibility may be used as a condition. That is, in step S23d, the parameters may be selected on condition that a high noise reduction effect can be achieved. Note that high audibility means that the lines indicating the frequency characteristics of the noise levels are smooth and have no localized unevenness.

### [Exemplary Operation 3 of Setting System]

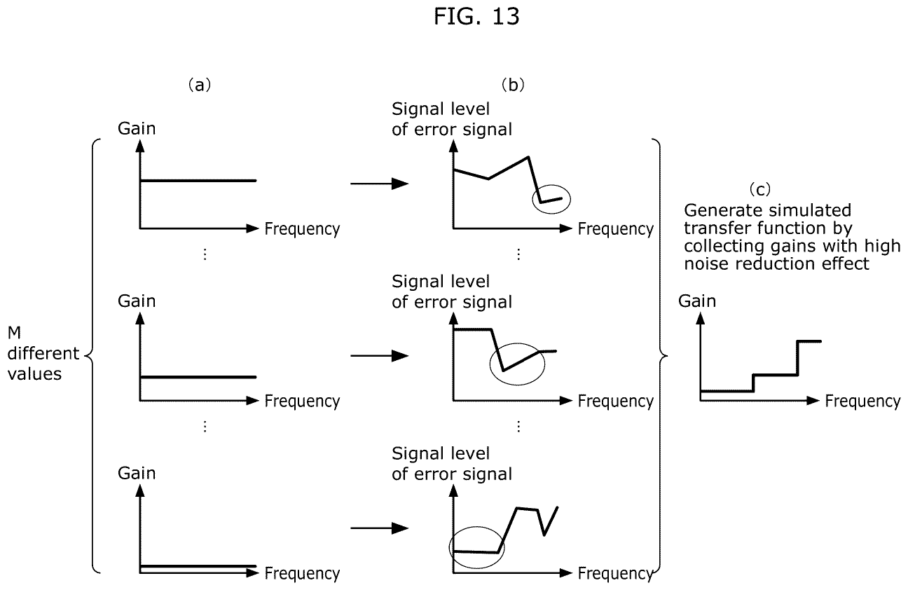

The next description is given regarding an operation (exemplary operation 3) of generating a simulated acoustic transfer function in accordance with a round robin algorithm different from the genetic algorithm and storing the generated simulated acoustic transfer function in storage 16. First, an overview of the round robin algorithm will be described. FIG. 13 is a diagram for describing the round robin algorithm.

In the following description, an ultimate simulated transfer function is described as the second simulated transfer function, and a provisional simulated transfer function for use in determining the second simulated transfer function is described as the first simulated transfer function. Although the following describes a case in which N first parameters (or second parameters) that configure the first simulated transfer function (or the second simulated transfer function) are gains, the first parameters (or the second parameters) may be phases.

In the round robin algorithm, values that can be taken by each of the N first parameters are any of M different values (in other words, predetermined candidate values) determined in advance. M is a natural number greater than or equal to two. Information processing unit 22 of information terminal 20 performs processing for provisionally setting each of the N first parameters to one of the M different values ((a) in FIG. 13) and simulating frequency characteristics at the signal level of an error signal ((b) in FIG. 13). This processing is performed using all of the M different values. In other words, information processing unit 22 performs processing for generating the first simulated transfer function including N first parameters having provisionally set values, and simulating a noise reduction effect of active noise reduction device 10 that is assumed to be achieved in the case of using the generated first simulated transfer function, and this processing is performed M times while changing the provisionally set values to the M different values.

Then, for each of the N first parameters, information processing unit 22 adopts a value that shows the lowest signal level of the error signal (a value with which the highest noise reduction effect is achieved) from among the M different values as the ultimate second parameter so as to generate the second simulated transfer function that is considered to achieve the highest noise reduction effect ((c) in FIG. 13). In other words, the second simulated transfer function including the N second parameters is generated by selecting, as each of the second parameter, a first parameter that achieves the highest noise reduction effect from among M different first parameters that correspond to one frequency value.

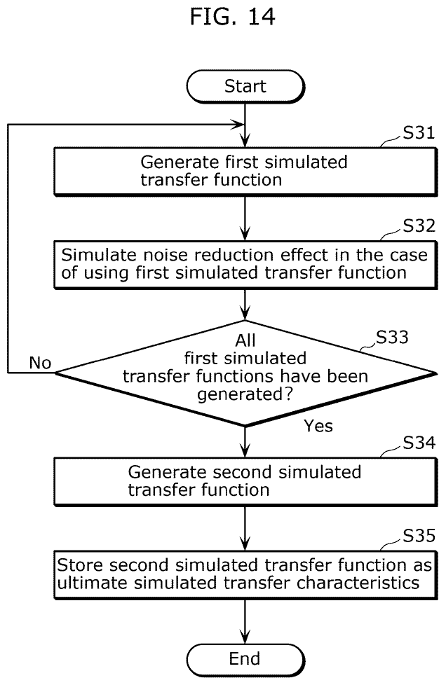

The following description is given regarding exemplary operation 3 using the round robin algorithm. FIG. 14 is a flowchart of exemplary operation 3 of setting system 30. For example, exemplary operation 3 described below may be performed using, as a trigger, a predetermined operation performed by an operator on information terminal 20.

Information processing unit 22 of information terminal 20 generates a first simulated transfer function by provisionally setting all of the N first parameters to one of the M different values (S31). Information processing unit 22 simulates a noise reduction effect of active noise reduction device 10 that is assumed to be achieved in the case of using the generated first simulated transfer function (S32).

Then, information processing unit 22 determines whether all M different first simulated transfer functions have been generated (simulated) (S33). If it is determined that all the M different first simulated transfer functions have not yet been generated (No in S33), information processing unit 22 generates a first simulated transfer function by provisionally setting all of the N first parameters to one of the M different values that has not yet been tried (S31), and simulates a noise reduction effect of active noise reduction device 10 that is assumed to be achieved in the case of using the generated first simulated transfer function (S32). For example, information processing unit 22 may simulate frequency characteristics at the signal level of an error signal.

On the other hand, if it is determined that all the M different first simulated transfer functions have already been generated (Yes in S33), information processing unit 22 generates a second simulated transfer function by, for each of the N first parameters, adopting a value that achieves the highest noise reduction effect from among the M different values as a second parameter (S34). Specifically, information processing unit 22 generates the second simulated transfer function by, for each of the N first parameters, adopting a value of the M different values that shows the lowest signal level of the error signal as a second parameter (S34).

Then, information processing unit 22 stores the second simulated transfer function in storage 16 of active noise reduction device 10 (S35). Specifically, information processing unit 22 transmits the second simulated transfer function to active noise reduction device 10 via communicator 21 in order to store the second simulated transfer function in storage 16 of active noise reduction device 10.

In this way, setting system 30 generates the second simulated transfer function that is considered to achieve a high noise reduction effect in accordance with the round robin algorithm, and stores the generated second simulated transfer function as a simulated transfer function for use in the generation of the cancellation sound in storage 16 of active noise reduction device 10.

In the generation of the second simulated transfer function in step S34, parameters are selected on condition that the signal level of the error signal becomes lowest during simulation, but in addition to or instead of the signal level of the error signal, highest audibility may be used as a condition. That is, in step S34, the parameters may be selected on condition that the highest noise reduction effect can be achieved.

### [Variations]

Although the above embodiment has described an example of reducing muffled engine sound (noise having a correlation with the engine speed of engine 54), for example, active noise reduction device 10 may reduce noise having a correlation with the revolutions of a propeller shaft. As another alternative, active noise reduction device 10 may reduce noise caused by actuation of a power source other than engine 54.

Although the above embodiment has described an example of reducing one order component (e.g., a second-order component) of noise such as muffled engine sound, active noise reduction device 10 may reduce a plurality of order components (e.g., a second-order component and a four-order component) of noise at the same time (in parallel).

In the above embodiment, the following three methods are conceivable as the method of generating the simulated transfer function: a conventional method using as-is measurement data (or as-is instances of measurement data), a method based on the genetic algorithm, and a method based on the round robin algorithm. Here, different methods may be adopted to generate phases and gains. For example, the phases of the simulated transfer function may be generated by the method using the as-is measurement data, and the gains of the simulated transfer function may be generated by the method based on the genetic algorithm or the round robin algorithm.

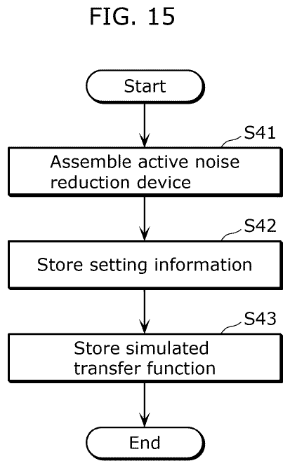

Exemplary operations 1 to 3 of the setting system according to the above embodiment have described the setting method relating to active noise reduction device 10. Here, if the above-described setting method is performed as part of the process of manufacturing active noise reduction device 10, the above-described setting method can be thought of as a method of manufacturing the active noise reduction device. FIG. 15 is a flowchart of the method of manufacturing active noise reduction device 10.

As shown in FIG. 15, the method of manufacturing active noise reduction device 10 involves assembling active noise reduction device 10 (S41), storing the setting information in storage 16 of assembled active noise reduction device 10 in accordance with exemplary operation 1 (S42), and storing the simulated transfer function that is used for the generation of the cancellation sound in accordance with exemplary operation 2 or 3 (S43). In this way, aspects derived from the disclosure described in the specification of the present application includes the method of manufacturing active noise reduction device 10.

### Advantageous Effects

Aspects derived from the disclosure described in the present specification of the present application are for example as follows. Hereinafter, the aspects derived from the disclosure described in the specification of the present application will be described in combination with advantageous effects achieved by these aspects.

Aspect 1 is a setting method relating to active noise reduction device 10 and to be executed by a computer such as information terminal 20. When noise caused by revolutions of engine 54 of vehicle 50 (mobile object) is detected in space 51 of vehicle 50 where loudspeaker 52 and microphone 53 are provided, active noise reduction device 10 reduces the detected noise by outputting cancellation sound from loudspeaker 52.

The setting method includes step S11 of acquiring plurality of instances of measurement data of an acoustic transfer function from the position of loudspeaker 52 to the position of microphone 53, step S12 of identifying a frequency band in which measurement variation of the acquired instances of measurement data is greater than a threshold value, and step S13 of storing setting information in storage 16 of active noise reduction device 10, the setting information being information for configuring active noise reduction device 10 with a setting that prevents output of the cancellation sound when noise corresponding to the identified frequency band is detected. Vehicle 50 is one example of the mobile object, and engine 54 is one example of the power source.

With this setting method, when noise is detected that has a frequency corresponding to the except band susceptible to changes in the actual acoustic transfer function, active noise reduction device 10 does not output the cancellation sound, thereby suppressing an increase in noise caused by the cancellation sound. That is, the setting method suppresses an increase in noise caused by the cancellation sound that is output in order to reduce noise. In other words, the setting method improves stability of noise reduction performance.

Aspect 2 is the setting method according to Aspect 1 that further includes step S22 of generating a first simulated transfer function based on the acquired instances of measurement data, the first simulated transfer function including N first parameters that correspond respectively to N different frequency values, where N is a natural number greater than or equal to two, and step S25 of storing the first simulated transfer function in storage 16 of active noise reduction device 10, the first simulated transfer function having been updated for a predetermined count in accordance with a genetic algorithm.

With this setting method, the first simulated transfer function generated in accordance with the genetic algorithm is stored in storage 16 of active noise reduction device 10.

Aspect 3 is the setting method according to Aspect 2, in which the updating of the first simulated transfer function includes simulating a noise reduction effect of active noise reduction device 10 that is assumed to be achieved in the case of using the first simulated transfer function, generating a second simulated transfer function including N second parameters by changing each of the N first parameters randomly within a predetermined numerical range, simulating a noise reduction effect of active noise reduction device 10 that is assumed to be achieved in the case of using the generated second simulated transfer function, and determining a third simulated transfer function as an updated first simulated transfer function, the third simulated transfer function including N third parameters that correspond respectively to N different frequency values, the N third parameters each being obtained by selecting, as the third parameter, a parameter that achieves a higher noise reduction effect from a first parameter and a second parameter that correspond to one of the frequency values.

With this setting method, the first simulated transfer function generated in accordance with the genetic algorithm and considered to achieve a high noise reduction effect is stored in storage 16 of active noise reduction device 10.

Aspect 4 is the setting method according to Aspect 3, in which in the updating of the first simulated transfer function for the predetermined count, some of the N first parameters may be changed beyond the predetermined numerical range.

This setting method reduces the possibility that the first parameters will fall into so-called local solutions and fail to approach optimum solutions.

Aspect 5 is the setting method according to Aspect 1 that further includes the step of performing processing for generating a first simulated transfer function including N first parameters and simulating a noise reduction effect of active noise reduction device 10 that is assumed to be achieved in the case of using the generated first simulated transfer function, the N first parameters having provisionally set values and corresponding respectively to N different frequency values, where N is a natural number greater than or equal to two, the processing being performed M times while changing the provisionally set values to each of M different values, where M is a natural number greater than or equal to two, and the step of storing a second simulated transfer function including N second parameters that correspond respectively to N different frequency values in storage 16 of active noise reduction device 10, the N second parameters each being obtained by selecting, as the second parameter, a first parameter that achieves a highest noise reduction effect from among M first parameters that correspond to one frequency value.

With this setting method, the second simulated transfer function that is considered to achieve a high noise reduction effect is stored in storage 16 of active noise reduction device 10.

Aspect 6 is a method of manufacturing active noise reduction device 10. The manufacturing method includes step S41 of assembling active noise reduction device 10, and step S42 of executing the setting method according to Aspect 1 to store the setting information in storage 16 of assembled active noise reduction device 10.

With this method of manufacturing active noise reduction device 10, it is possible to manufacture active noise reduction device 10 that reduces the possibility that noise will be increased actually by the cancellation sound that is output with the intention of reducing noise. In other words, the active noise reduction device with improved stability of noise reduction performance can be manufactured by the method of manufacturing active noise reduction device 10.

Aspect 7 is a program for causing a computer to execute the setting method according to any one of Aspects 1 to 5.

With this program, the computer reduces the possibility that noise will be increased actually by the cancellation sound that is output with the intention of reducing noise. In other words, the computer improves stability of noise reduction performance.

Aspect 8 is information terminal 20 that makes settings relating to active noise reduction device 10. When noise caused by revolutions of engine 54 of vehicle 50 is detected in space 51 of vehicle 50 where loudspeaker 52 and microphone 53 are provided, active noise reduction device 10 reduces the detected noise by outputting cancellation sound from loudspeaker 52.

Information terminal 20 includes information processing unit 22 that acquires a plurality of instances of measurement data of an acoustic transfer function from the position of loudspeaker 52 to the position of microphone 53. Information processing unit 22 identifies a frequency band in which measurement variation of the acquired instances of measurement data is greater than a threshold value, and stores setting information in storage 16 of active noise reduction device 10, the setting information being information for configuring active noise reduction device 10 with a setting that prevents output of the cancellation sound when noise corresponding to the identified frequency band is detected.

Information terminal 20 reduces the possibility that noise will be increased actually by the cancellation sound that is output with the intention of reducing noise. In other words, information terminal 20 improves stability of noise reduction performance.

### Other Embodiments

While the embodiment has been described thus far, the present disclosure is not intended to be limited to the above-described embodiment.

For example, the active noise reduction device according to the above-described embodiment may be mounted on a mobile object other than a vehicle. For example, the mobile object may be an airplane or a marine vessel. The present disclosure may also be realized as a mobile object other than those vehicles.

The configuration of the active noise reduction device according to the above-described embodiment is merely one example. For example, the active noise reduction device may include constituent elements such as a digital analog (D/A) converter, a low-pass filter (LPF), a high-pass filter (HPF), a power amplifier, or an analog digital (A/D) converter.

The processing performed by the active noise reduction device according to the above-described embodiment is merely one example. For example, part of the processing described in the above embodiment may be realized by analog signal processing, instead of digital signal processing.

In the above-described embodiment, for example, processing that is executed by a specific processing unit may be executed by a different processing unit. A sequence of a plurality of processing steps in the operation of the active noise reduction device described in the above embodiment is merely one example. The processing steps may be performed in a different sequence, or a plurality of processing steps may be executed in parallel. Similarly, a sequence of a plurality of processing steps in the operation of the setting system described in the above embodiment is also merely one example. The processing steps may be performed in a different sequence, or a plurality of processing steps may be executed in parallel.

Note that general or specific aspects of the present disclosure may be realized as a system, a device, a method, an integrated circuit, a computer program, or a non-transitory recording medium such as a computer-readable CD-ROM. These aspects may also be realized as any combination of a system, a device, a method, an integrated circuit, a computer program, and a non-transitory computer-readable recording medium.

For example, the present disclosure may be realized as the information terminal or the setting system according to the above-described embodiment. The present disclosure may also be realized as the setting method, the method of manufacturing an active noise reduction device, or the method of generating a simulated transfer function described in the above embodiment. The present disclosure may also be realized as a program (program product) for causing a computer to execute these methods, or may be realized as a non-transitory computer-readable recording medium having such a program recorded thereon.

Other modifications obtained by applying various changes conceivable by a person skilled in the art to the embodiments and modifications and any combinations of the structural elements and functions in the embodiments and modifications without departing from the scope of the present disclosure are also included in the present disclosure.

While various embodiments have been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in their entirety: Japanese Patent Application No. 2024-204141 filed on Nov. 22, 2024.

### INDUSTRIAL APPLICABILITY

A setting method according to the present disclosure improves noise reduction performance of an active noise reduction device.

1. A setting method relating to an active noise reduction device and to be executed by a computer,
the active noise reduction device, when noise caused by a revolution of a power source of a mobile object is detected in a space of the mobile object where a loudspeaker and a microphone are provided, reducing the noise detected, by outputting cancellation sound from the loudspeaker,
the setting method comprising:
acquiring a plurality of instances of measurement data of an acoustic transfer function from a position of the loudspeaker to a position of the microphone;
identifying a frequency band in which measurement variation of the plurality of instances of measurement data acquired is greater than a threshold value; and
storing setting information in a storage of the active noise reduction device, the setting information being information for configuring the active noise reduction device with a setting that prevents output of the cancellation sound when noise corresponding to the frequency band identified is detected.

2. The setting method according to claim 1, the setting method further comprising:
generating a first simulated transfer function based on the plurality of instances of measurement data acquired, the first simulated transfer function including N first parameters that correspond respectively to N different frequency values, where N is a natural number greater than or equal to two; and
storing the first simulated transfer function in the storage of the active noise reduction device, the first simulated transfer function having been updated for a predetermined count in accordance with a genetic algorithm.

3. The setting method according to claim 2,
wherein the updating of the first simulated transfer function includes:
simulating a noise reduction effect of the active noise reduction device that is assumed to be achieved when the first simulated transfer function is used;
generating a second simulated transfer function including N second parameters by changing each of the N first parameters randomly within a predetermined numerical range;
simulating a noise reduction effect of the active noise reduction device that is assumed to be achieved when the second simulated transfer function generated is used; and
determining, as the first simulated transfer function updated, a third simulated transfer function including N third parameters that correspond respectively to N different frequency values, the N third parameters each being obtained by selecting, as the third parameter, a parameter that achieves a higher noise reduction effect from a first parameter and a second parameter that correspond to one of the N different frequency values.

4. The setting method according to claim 3,
wherein in the updating of the first simulated transfer function for the predetermined count, some of the N first parameters are changed beyond the predetermined numerical range.

5. The setting method according to claim 1, the setting method further comprising:
performing processing for generating a first simulated transfer function including N first parameters having provisionally set values and corresponding respectively to N different frequency values, where N is a natural number greater than or equal to two, and simulating a noise reduction effect of the active noise reduction device that is assumed to be achieved when the first simulated transfer function generated is used, the processing being performed M times by changing the provisionally set values to M different values, where M is a natural number greater than or equal to two; and
storing a second simulated transfer function in the storage of the active noise reduction device, the second simulated transfer function including N second parameters that correspond respectively to N different frequency values, the N second parameters each being obtained by selecting, as the second parameter, a first parameter that achieves a highest noise reduction effect from among M different first parameters that correspond to one of the N different frequency values.

6. A method of manufacturing an active noise reduction device, the method comprising:
assembling an active noise reduction device; and
executing the setting method according to claim 1 to store the setting information in a storage of the active noise reduction device assembled.

7. A non-transitory computer-readable recording medium having recorded thereon a program for causing a computer to execute the setting method according to claim 1.

8. An information terminal that makes a setting relating to an active noise reduction device,
wherein, when noise caused by a revolution of a power source of a mobile object is detected in a space of the mobile object where a loudspeaker and a microphone are provided, the active noise reduction device reduces the noise detected, by outputting cancellation sound from the loudspeaker,
the information terminal comprising:
an information processing unit that acquires a plurality of instances of measurement data of an acoustic transfer function from a position of the loudspeaker to a position of the microphone,
wherein the information processing unit:
identifies a frequency band in which measurement variation of the plurality of instances of measurement data acquired is greater than a threshold value; and
stores setting information in a storage of the active noise reduction device, the setting information being information for configuring the active noise reduction device with a setting that prevents output of the cancellation sound when noise corresponding to the frequency band identified is detected.
